(19) United States
(12) Patent Application Publication
(10) Pub. No.: US 2016/0057804 A1
(43) Pub. Date: Feb. 25, 2016

(54) Optimizing Channel State Switch based on the Traffic Volume Indicator (TVI) Values Associated with Throughputs on the Communication Links

(71) Applicant: TELEFONAKTIEBOLAGET L M ERICSSON (PUBL), Stockholm (SE)

(72) Inventors: Johnny Karlsen, Järfälla (SE); Lars Bergenlid, Sollentuna (SE); Anders Carlsson, Danderyd (SE); Frank Mueller, Upplands-Väsby (SE); Jonas Wiorek, Sollentuna (SE); Mats Zachrison, Örebro (SE)

(21) Appl. No.: 14/780,606

(22) PCT Filed: Mar. 28, 2013
(86) PCT No.: PCT/SE2013/050358

§ 371 Date: Sep. 28, 2015

(51) Int. Cl. H04W 76/04

(52) U.S. Cl. CPC H04W 76/046

(57) ABSTRACT

The embodiments herein relate to a method in a network node (101) for handling states associated with a wireless device (105) in a communications network (100). The network node (101) is connected to the wireless device (105) over a communications link (110). The communications link (110) is in a current state. The network node (101) receives, from the wireless device (105) information related to a data activity in the wireless device (105). The received information comprises at least information other than a current amount of data associated with the data activity. Based on the received information, the network node (101) determines a change associated with the current state.

### TECHNICAL FIELD

Embodiments herein relate generally to a network node, a method in the network node, a wireless device and a method in the wireless device. More particularly the embodiments herein relate to handling states associated with a wireless device in a communications network.

### BACKGROUND

In a typical communications network, a wireless device communicates via a Radio Access Network (RAN) to one or more Core Networks (CNs). The communications network may also be referred to as e.g. a wireless communications network, a wireless communications system, a communications network, a communications system, a network or a system.

The wireless device may be a device by which a subscriber may access services offered by an operator's network and services outside the operator's network to which the operator's radio access network and core network provide access, e.g. access to the Internet. The wireless device may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device or any type of consumer electronic, for instance but not limited to television, radio, lighting arrangements, tablet computer, laptop or Personal Computer (PC). The wireless device may be portable, pocket storable, hand held, computer comprised, or vehicle mounted devices, enabled to communicate voice and/or data, via the radio access network, with another entity, such as another wireless device or a server.

The wireless device is enabled to communicate wirelessly within the communications network. The communication may be performed e.g. between two wireless devices, between a wireless device and a regular telephone and/or between the wireless device and a server via the radio access network and possibly one or more core networks and possibly the Internet.

The communications network covers a geographical area which is divided into cell areas, with each cell area being served by a base station. The base station is also called a Radio Base Station (RBS), evolved NodeB (eNB), NodeB or B node in some communications networks. A cell is a geographical area where radio coverage is provided by the base station at a base station site. The base station communicates with the wireless device(s) within range of the base station.

Wideband Code Division Multiple Access (WCDMA) is the radio technology of Universal Mobile Telecommunications System (UMTS) and is one of the main technologies for the implementation of third generation (3G) communications networks. Long Term Evolution (LTE) or the Evolved Universal Terrestrial Access Network (E-UTRAN) is also referred to as a fourth generation (4G) communications technology and is a standard for wireless communication of high-speed data for mobile phones and data terminals. WCDMA and LTE have a number of radio states with different capabilities and characteristics related to data throughput, battery and consumed system recourses. A state may also be referred to as a mode. For example, depending on the amount of data to be transmitted or received, the radio network system may order the wireless device connection to a particular state. In the following, it is the communications link that is referred to as being in a certain state. However, it is off course the communications link and the modem parts of the network node and the wireless device that together are in a certain state.

WCDMA has the following states:
URA_PCH
Cell_PCH
Idle
Cell_DCH
Cell_FACH

PCH in URA_PCH and Cell_PCH is short for Paging Channel, URA is short for Utran Registration Area and Utran is short for Universal Terrestrial Radio Access Network. DCH in Cell_DCH is short for Dedicated CHannel and FACH in Cell_FACH is short for Forward Access CHannel. In idle, the radio is off and no radio resources are utilized.

The above mentioned states, in order of decreasing power consumption or decreasing data throughput are Cell_DCH, Cell_FACH, Cell_PCH, URA_PCH for WCDMA. For example, power consumption in Cell_FACH is around 50% of that in Cell_DCH. The PCH states use about 1-2% of the power consumption of Cell_DCH. The states Cell_DCH, Cell_FACH, Cell_PCH and URA_PCH are Radio Resource Control (RRC) states in UTRA RRC Connected Mode.

LTE has the following states:
Idle
   DRX in idle
Connected
   C-DRX in connected
   Awake in connected.

DRX is short for Discontinuous Reception and is enabled in both idle and connected mode. As seen above, there are two basic states in LTE: idle mode and connected mode. In idle mode, the communications link may be in DRX or not, i.e. listening for a page message. This is referred to as DRX in idle mode and idle mode. In connected mode, a DRX pattern is followed (whether DRX is supported or not) where the communications link is either in awake or in DRX. The DRX in connected mode may be referred to as C-DRX in order to differentiate it from DRX in idle mode. This is referred to as awake in connected mode and C-DRX in connected mode. In connected, the radio is on, uses high power and data is transmitted or received. In idle, the radio is off and uses low power. In C-DRX the radio is periodically woken up and shut down.

In WCDMA, a communications link between a network node and a wireless device on which any data is transmitted or received will either typically reside in one of the states URA_PCH or Cell_PCH. In the states URA_PCH and Cell_PCH it is not possible to transfer (send/receive) any Internet Protocol (IP) user data, i.e. there is no data transmission on the communications link when in URA_PCH or Cell_PCH or in idle. In a similar way an LTE device not sending data will reside in Idle or in a DRX sleep cycle. In these states it is not possible to transfer any IP user data.

In order to transfer IP user data the wireless device connection must be upgraded to one of the states referred to as Cell_DCH or Cell_FACH in case of WCDMA and to connected state in case of LTE. This re-assignment to Cell_DCH or Cell_FACH or to a connected state may happen for different reasons such as that an application running on the wireless device needs to send and/or request data from/to a server on the communications network or a server on the network need to send and/or receive data to/from the wireless device.

Using WCDMA as an example. WCDMA has a concept called a WCDMA RRC state machine. In general, a state machine is a description model which may be in one of a number of states. The state machine is in only one state at a time, and the state it is in at any given time is called the current state. The state machine may change from one state to another when initiated by a triggering event or condition; this is called a transition. There may be a state machine in the wireless device and in the radio access network, e.g. the network node. In WCDMA, the state machine has limited amount of information to determine a transition to another state. In fact, the WCMDA RRC state machine uses the initial amount of data in a first buffer of the wireless device as a basis for determining a transition from URA_PCH or Cell_PCH to one of the other states Cell_DCH or Cell_FACH. If the initial amount of data in the first buffer has reached or is above a threshold, a transition from URA_PCH or Cell_PCH to one of the other states Cell_DCH or Cell_FACH is performed. For example, if the wireless device is in URA_PCH and has 33 bytes in its initial buffer which is to be transmitted to a network node, the state machine uses this amount of bytes to determine the transition to another state, e.g. Cell_DCH or Cell_FACH, by using for example a threshold.

The third Generation Partnership Project (3GPP) Technical Standard 25.331, V11.4.0, for example in chapters 10.2.7, 8.3.1.3 and 14.4.2.1, describes radio resource control messages and event based traffic volume measurement reporting. The wireless device transmits a cell update message to the UTRAN. The cell update message may comprise an optional information element referred to as a Traffic Volume Indicator (TVI). The TVI is an enumerated information element and it shall be set to TRUE when the monitored transport channel traffic volume is larger than a threshold, and thus that the communications link associated with the wireless device may be in the state Cell_DCH. Absence of the TVI means that the monitored transport channel traffic volume is below the threshold, and thus that the communications link associated with the wireless device may be in the state Cell_FACH. In a scenario where the TVI does not exist, but where the cell update is initiated as a result of uplink data transmission, the communications link also needs to be in Cell_FACH or Cell_DCH.

When the communications link is in URA_PCH or Cell_PCH and a wireless device initiates a transaction of data, it the state needs to change to Cell_FACH or Cell_DCH since these two states are the states in which there may be data transactions on the communications link. When the wireless device initiates the transaction and based on traffic volume measurements it may set or not set the TVI in order to indicate the amount of data in its initial buffer.

For a transaction initiated by a network node or an application comprised in the network node, the network node or application would typically not signal that the amount of data has reached or is above the predefined value as the transaction was initiated from the network node. The network node only transmits instructions to the wireless device indicating which state it has determined.

A server initiated transaction will lead to IP packets arriving to the mobile core network and Radio Network Controller (RNC). Such server may be for example a mail server. Various techniques may be used to decide what state to assign the wireless device to. The decision may be based on an initial size of a buffer which is readily available in the network node. This buffer is a buffer associated with the specific transport channel on the network node side. The data in the buffer has not yet reached the wireless device. This state upgrade from URA_PCH or Cell_PCH to Cell_FACH or Cell_DCH initiated by the network node is a separate process from the upgrade triggered or initiated by the wireless device. As mentioned above, the initiative to transmit data is taken from a server located somewhere on the Internet. The data to be transmitted arrives at the core network and the RNC which takes a decision to upgrade the communications link in order to get the data to the wireless device.

WO 2010/047630 relates to handling states in LTE. The network node uses the flow of data and activation times for one individual wireless device or the aggregated traffic, in order to determine how to set the inactivity or DRX parameters. This is in order to optimize the time the individual wireless device spends in the separate states, to avoid unnecessary state switching, save resources, or provide better battery life time for the wireless device. The decision is solely made by the network node and is based on passive traffic monitoring only.

PCT/EP2012/070473 describes a method to decide when to change state of a communication channel between a network node and a wireless device. The proposed method is based on three procedures, determination, prediction and decision procedures. The three procedures are each performed over a time interval following each other. The determination procedure uses the amount of buffered data and time interval between packets to determine the actual traffic activity. The prediction procedure uses the amount of buffered data and time interval between packets to predict the traffic activity in the near future. The decision procedure uses the predict traffic activity to decide if to switch states.

A problem with the existing technology based on the initial buffer size signaled from the wireless device to the network node is that the initial buffer size may be small and in most cases this would lead the network node to transition the wireless device to the Cell_FACH state and then later make an additional re-transition to Cell_DCH leading to additional latency. A transition to Cell_DCH on every buffer size in the wireless device leads to unnecessary battery drain of the wireless device and system resource consumption.

Another problem is that the basis for the network node's decision regarding the states is very limited and may not always lead to the most optimal state switching.

### SUMMARY

An object of embodiments herein is therefore to obviate at least one of the above disadvantages and to provide improved handling of states in a communications network.

According to a first aspect, the object is achieved by a method in a network node for handling states associated with a wireless device in a communications network. The network node is connected to the wireless device over a communications link. The communications link is in a current state. The network node receives, from the wireless device, information related to a data activity in the wireless device. The received information comprises at least information other than a current amount of data associated with the data activity. Based on the received information, the network node determines a change associated with the current state.

According to a second aspect, the object is achieved by a method in a wireless device for handling states associated with the wireless device in a communications network. The wireless device is connected to a network node over a communications link. The communication link is in a current state. The wireless device obtains information related to a data activity in the wireless device. The information comprises at least information other than a current amount of data associated with the data activity. The wireless device transmits the information to the network node.

According to a third aspect, the object is achieved by a network node for handling states associated with a wireless device in a communications network. The network node is connected to the wireless device over a communications link. The communications link is in a current state. The network node comprises a receiver which is adapted to receive, from the wireless device, information related to a data activity in the wireless device. The received information comprises at least information other than a current amount of data associated with the data activity. The network node comprises a determining unit adapted to determine, based on the received information, a change associated with the current state.

According to a fourth aspect, the object is achieved by a wireless device for handling states associated with the wireless device in a communications network. The wireless device is connected to a network node over a communications link. The communication link is in a current state. The wireless device comprises an obtaining unit which is adapted to obtain information related to a data activity in the wireless device. The information comprises at least information other than a current amount of data associated with the data activity. The wireless device comprises a transmitter which is adapted to transmit the information to the network node.

Since the network node's decision to make a change associated with the current state is based on information received from the wireless device which is at least other than the current amount of data to be transmitted by the wireless device, the handling of states in the communications network is improved. Traditionally, changes associated with the states have been controlled without deeper understanding of the ongoing data traffic in the communications network. This may lead to poor utilization of resources and not optimal user experience in terms of the latency the user is subject to. Therefore by bringing more knowledge to the state change process and thereby give the possibility to increase user experience and at the same time better utilize the battery and system resources. By bringing knowledge available in the wireless device to the network node which is responsible for the control of state switching and the overall resource utilization, the handling of the states is improved.

Embodiments herein afford many advantages, of which a non-exhaustive list of examples follows:

An advantage of the embodiments herein is that unnecessary state switching and latency is reduced, this without compromising system load and battery drain of the wireless device. This improves the user experience for example for user interactive use cases.

By letting the network node having access to information related to ongoing data traffic in the communications network, it may use this information in taking a decision on where to and when to switch to another state. The information may be what the user is doing with its wireless device, if anything at all, what application is actually generating data, is the screen on, is the wireless device moving or laying still etc. This kind of information is of value for the network node in order to provide the advantage of taking better informed decisions.

Another advantage is an optimized state switching and transmission characteristics selection behavior; by means of making device information available to the network node. The network node performing the state switching may then optimize the behavior from a number of different aspects, user latency, battery drain in the wireless device, system load or a combination of the three. The network node still has the option of optimizing differently under various circumstances; i.e. in a situation with high system load it may be beneficial to optimize strictly on the system load aspect.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating embodiments of a communications network.

FIG. 2 is a signaling diagram illustrating embodiments of a method in a communications network.

FIG. 3 is a signaling diagram illustrating embodiments of a method in communications network.

FIG. 4 is a signaling diagram illustrating embodiments of a method in communications network.

FIG. 5 is a flow chart illustrating embodiments of a method in a network node.

FIG. 6 is a flow chart illustrating embodiments of a method in a wireless device.

FIG. 7 is a schematic block diagram illustrating embodiments of a network node.

FIG. 8 is a schematic block diagram illustrating embodiments of a wireless device.

FIG. 9 is a schematic block diagram illustrating embodiments of a communications network.

The drawings are not necessarily to scale and the dimensions of certain features may have been exaggerated for the sake of clarity. Emphasis is instead placed upon illustrating the principle of the embodiments herein.

### DETAILED DESCRIPTION

In the embodiments, herein the wireless device collects and processes data in order to convey a number of parameters to the network node which describe the current and possibly future behavior of the data packet stream. This will enable the network node to take a more informed, and from various aspects more optimized, decision on state switching and transmission characteristics for the wireless device. The embodiments herein relate to state and transmission characteristics selection based on wireless device/application knowledge made available to the network node.

The wireless device including its Operating System (OS) sits on a multitude of data to deduce what kind of use case that is causing a current network data activity. The network node may use this information together with other information in the system to group the different possible traffic scenarios into a number of use cases each one requiring or benefitting from a different handling in the radio state machine.

The information from the wireless device may be made available to the system side, i.e. the network node, in a range of aggregation levels. In one embodiment, data from a number of different information sources from the wireless device are sent from the wireless device to the network node and all of the deduction and grouping into use cases with an impact on radio transmission is done on by the network nod, examples of such information sources may be state of screen (on/off), end user interaction, application type in the foreground, application type currently sending data, etc. In another embodiment, there are a number of pre agreed use cases and the wireless device is from its sources responsible for deducting which use case is running and inform the network node about which. A number of in between versions of this are of course also possible where the wireless device makes its best estimate on use case available but also supply information from the sources used.

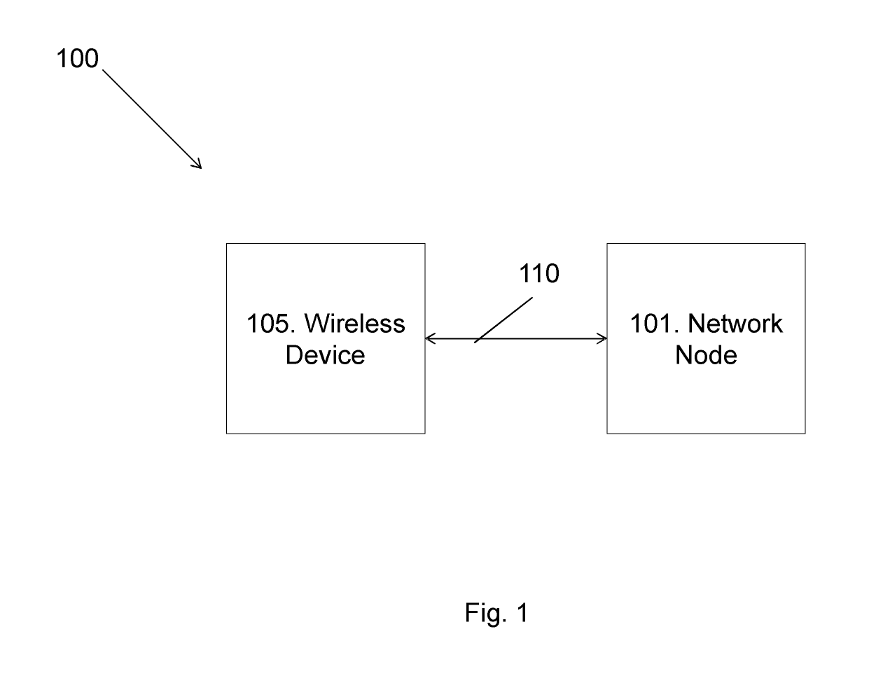

FIG. 1 depicts a communications network 100 in which embodiments herein may be implemented. The communications network 100 may in some embodiments apply to one or more radio access technologies such as WCDMA or LTE.

The communications network 100 comprises a network node 101 capable of communicating with a wireless device 105 over a communications link 110.

The network node 101 may be a RNC, a Mobility Management Entity (MME), a Serving GateWay (SGW), a base station such as an eNB or NodeB, or any other network unit capable of communicating with the wireless device 105 over the communications link 110.

The wireless device 105 may be a device by which a subscriber may access services offered by an operator's network and services outside operator's network to which the operator's radio access network and core network provide access, e.g. access to the Internet. The wireless device 105 may be any wireless device, mobile or stationary, enabled to communicate over a radio channel in the communications network, for instance but not limited to e.g. user equipment, mobile phone, smart phone, sensors, meters, vehicles, household appliances, medical appliances, media players, cameras, M2M device or any type of consumer electronic, for instance but not limited to television, radio, lighting arrangements, tablet computer, laptop or PC. The wireless device 105 may be portable, pocket storable, hand held, computer comprised, or vehicle mounted devices, enabled to communicate voice and/or data, via the radio access network, with another entity, such as another wireless device or a server.

It should be noted that the communications link 110 between the wireless device 105 and the network node 101 may be of any suitable kind. The communications link 110 may use any suitable protocol depending on type and level of layer, e.g. as indicated by the Open Systems Interconnection (OSI) model, as understood by the person skilled in the art.

The communications link 110, and consequently the modem parts of the network node 101 and the wireless device 105, is adapted to be in a state. The state in which the communication link 110 is at a current moment is from now on referred to as a current state. When necessary, there may be a change from the current state to a different state, or there may be a change of at least one parameter associated with the current state. Such parameter(s) affects the characteristics of the current state.

In the case where the communications network 100 is a WCDMA network, the current state may be URA_PCH, Cell_PCH, Cell_FACH or Cell_DCH. When in URA_PCH or Cell_PCH there is no data transmission on the communications link 110. When in Cell_FACH or Cell_DCH there is a data transmission on the communications link 110. Cell_DCH has a throughput on the communications link 110 which is higher than in Cell_FACH. The different state to which a change may be made is one of the four WCDMA states which is not the same as the current state.

In the case where the communications network 100 is an LTE network, the current state may be Idle, DRX in idle mode, awake in connected mode or C-DRX in connected mode. The different state to which a change may be made is one of the four LTE states which is not the same as the current state.

The states and the change associated with the states will be described in more detail below.

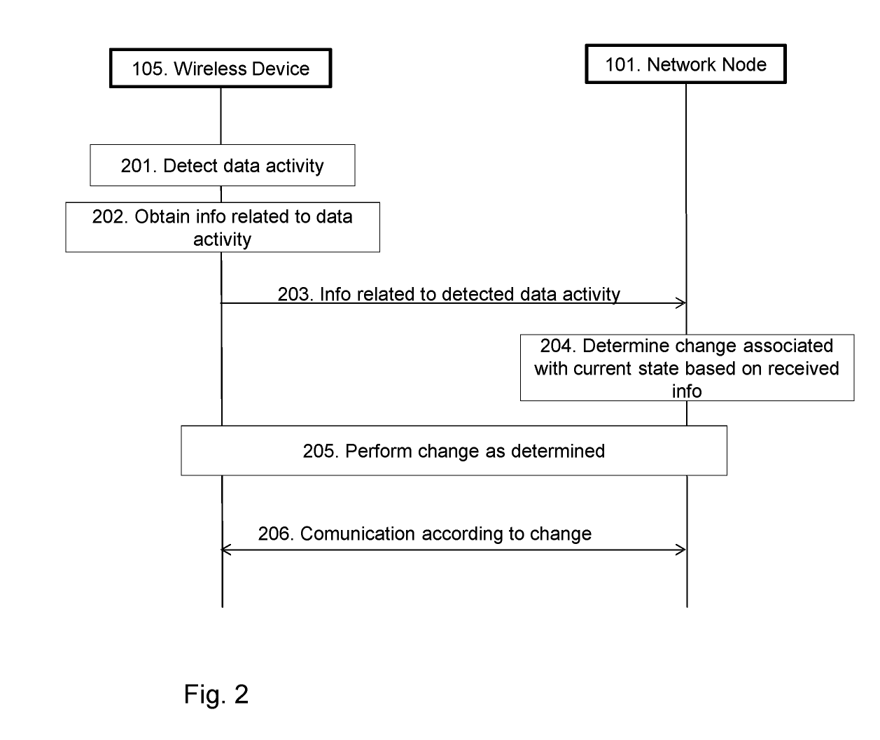

The method for handling states in the communications network 100, according to some embodiments will now be described with reference to the signaling diagram depicted in FIG. 2. In FIG. 2, the network node 101 is the node responsible for determining the change associated with the current state. The communications link 110 associated with the wireless device 105 is in a current state at the start of the method. The method comprises the following steps, which steps may as well be carried out in another suitable order than described below.

### Step 201

The wireless device 105 detects a data activity. The data activity may be related to that a user is doing something with its wireless device 105, that an application on the wireless device 105 is activated, that the screen on the wireless device 105 is on, that the wireless device 105 is moving or lying still etc.

### Step 202

The wireless device 105 obtains information related to the detected data activity.

In some embodiments, this may be pure collection of information related to the data activity and obtained from at least one information data source related to the data activity in the wireless device 105. Examples of such information sources may be a state of the screen of the wireless device 105 (on/off), end user interaction, application type in the foreground, application type currently sending data etc.

The information may be that the data activity is latency sensitive, that it may be prioritized, for example when the data activity is related to an emergency call or a data activity which a subscriber has a premium subscription to.

In another embodiment, the obtaining of information may also involve deducting which use case is running on the wireless device 105. The wireless device 105 may have information about a number of pre agreed use case, and deducts which using case is running based on the pre agreed use cases and the information from its information sources.

In a further embodiment, the wireless device 105 makes a best estimate on use case available.

Below a number of examples of possible use case and information data sources are listed.

### “Background Data Traffic” Use Case

The data traffic executed on the communications link 110 is non-user initiated background data traffic and may be executed with low throughput with a minimum of system load impact. In this case, the wireless device 105 may indicate that the use case is “background data traffic” to the network node 101. A number of different information data sources in the wireless device 105 may be used to deduct that this is background data traffic that do not have strong latency requirements. Data traffic initiated from the wireless device 105 without the user interacting with the wireless device 105, by data traffic time patterns recognized as scheduled polling of the service, device vendor pre-knowledge of the application that does not have strong latency requirements, the state of the screen of the wireless device 105, that the wireless device 105 is not interacted with or moved for a long time, the time of day etc. A combination of these and earlier learning by using a classification system may be used to draw conclusions about the use case.

The network side receiving information (step 204 described below) about the specific use case or information from information data sources may together with other system information sources take a decision on how to optimize the radio transmission. In WCDMA this may for example be to transmit the data in Cell_FACH or to give low priority to the wireless device 105 in the scheduler. In case of LTE, priority in the scheduler may be lower and DRX settings may be chosen which optimize resources on the expense of latency.

### “Early Channel” Use Case

Certain applications invocations by the user always leads to data requests which may be executed as fast as possible since the application in the wireless device 105 is waiting for information in order to render the user interface. In this case it is advantageous to let the wireless device 105 request a channel as soon as this intention is known so the setup procedure may execute in parallel to the application initiation. Information data sources used in this situation may be, pre-knowledge installed by the wireless device vendor, adaptive learning from screen presses and data generation, etc. This information need to be included in the setup request to the network node 101 in order to let the network node 101 take this information into account together with other system information as system load, channel quality, subscription type, wireless device type, when deciding on whether to allow this “Early channel” use case. In the WCDMA case this would be done by putting the wireless device link in state DCH ahead of data. In LTE, transmission start may be speed up by pre-scheduling.

### “Expecting More” Use Case

Even if a data transmission temporarily stops it may still be so that the user is interacting with the application on the wireless device 105 and remaining in a high throughput state may be beneficial from a user experience point of view. Or it may be beneficial from a network node point of view, to reduce switching, to remain in the current state. At the end of a transmission, the wireless device 105 may indicate its prediction for the future background or user initiated data predicted within a certain time. The network node 101 will use other input data (load in the specific cell, overall load on the system, . . . ) in order to take a decision on whether there is a gain in switching or remaining in same current state and waiting for next burst. Thus, there may be a separate indicator indicating user initiated data traffic.

The above use cases may be summarized as follows:

At the start of a data transmission, the wireless device 105 may signal “background data traffic” or “user initiated data traffic”, i.e. by using indicators. This may for example be handled with an extension to Cell update in the WCDMA case and by using Layer 2 extensions in LTE.

Before start of a data transmission the wireless device 105 may signal “Early channel” to enable fast switch up. This may for example be handled with an extension to Cell update in the WCMDA case and by using Layer 2 extensions in LTE.

During or at the end of an ongoing data transmission the wireless device 105 may signal “background data traffic” or “user initiated data traffic”. Included with this may also be a time prediction on when the future transmission burst is to be expected, 0 for ongoing. This may be an extension to a measurement report and the measurement type Traffic Volume in the WCDMA case and by using Layer 2 extensions in LTE.

The predefined use cases listed here should not be seen as the only possible, these are examples. As discussed previously, many levels of aggregation of device information is possible, either as pieces of information that the network node 101 may use to draw its own conclusion on what kind of use case is running or as more pre-defined use case that the wireless device 105 itself is taking a decision on which is running. The information is conveyed not only in the up-switch from Cell_PCH/URA_PCH but also in a number of other situations, and also for LTE.

Returning to FIG. 2.

### Step 203

The wireless device 105 transmits the obtained information to the network node 101. The information may be transmitted in a range of aggregation levels to the network node 101. The information may be the pure collection of information related to the data activity from the at least on information data source. The information may be information indicating the deducted use case. The information may be an estimate of a use case, and possibly in addition to information from the information sources.

### Step 204

When the network node 101 has received the information from the wireless device 105, it determines a change associated with the current state based on the received information. When the network node 101 has received information about the specific use case or information from information data sources, it may together with other system information sources take a decision on how to optimize the radio transmission.

If the information from the wireless device 105 in step 203 was pieces of information, the network node 101 needs to draw its own conclusion on what kind of use case the data activity is related to. If the information from the wireless device 105 comprises indications of the use case deducted by the wireless device 105 itself, it is not necessary for the network node 101 to perform any particular processing of the information from the wireless device 105.

In WCDMA, the change associated with the current state may be that the network node 101 decides to transmit the data in Cell_FACH or to give low priority to the wireless device 105 in the scheduler. In case of LTE, priority in the scheduler may be lower and DRX settings may be chosen which optimize resources on the expense of latency.

The determined change may also be to change a parameter associated with the current state, which parameter affects the characteristics of the current state. The C-DRX pattern will be affected by the embodiments herein when the network node 101 changes and signals the change of a C-DRX parameter which for example determines the length of the awake and sleep time, but also by triggering the network node 101 to signal to the wireless device 105 that it shall immediately enter DX before the awake time is over. The embodiments herein are also valid for setting of DRX parameters in idle.

### Step 205

After the network node 101 has taken its decision, it performs the determined change either by performing the change itself or by transmitting instructions to the wireless device 105 to perform the determined change.

For example, if the characteristics of the current state are to be changed, it is not necessary that the wireless device 105 has information about this change, i.e. it is not necessary to transmit any instructions to the wireless device 105. Sometimes the change is only within the network node 101, for example in the case with an inactivity timer in WCDMA. For LTE, a change of a DRX parameter may be transmitted to the wireless device 105.

### Step 206

When the change associated with the current state has been performed, the wireless device 105 and the network node 101 communicate according to the performed change.

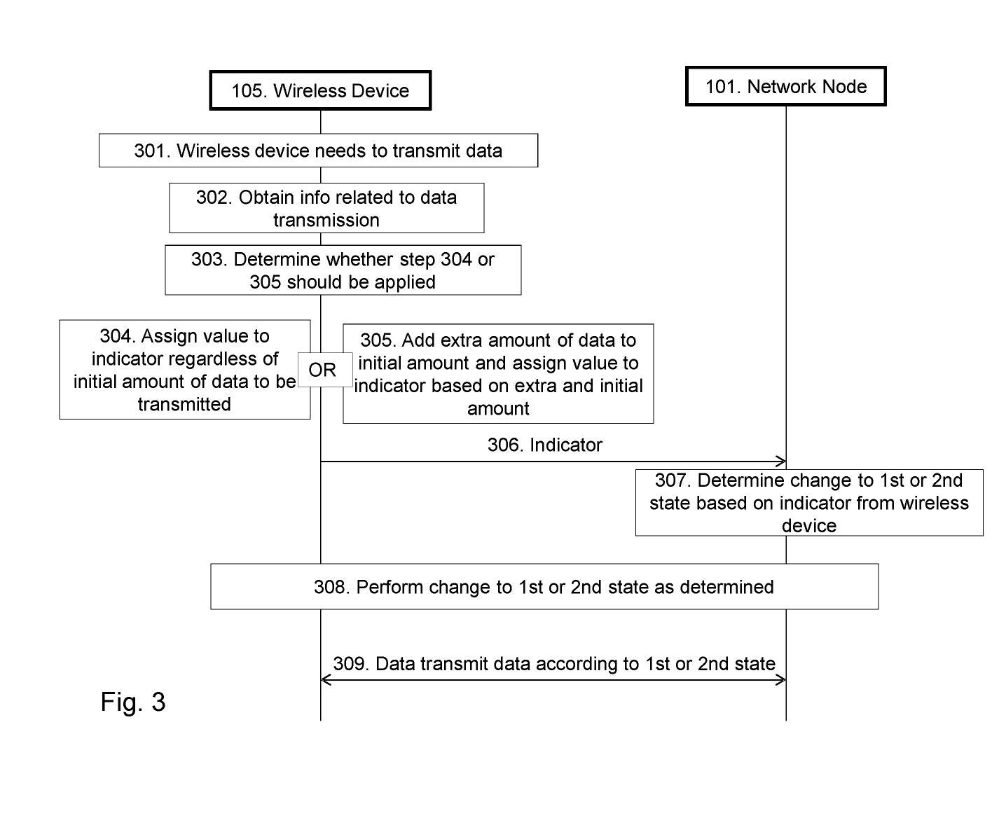

The method for handling states in the communications network 100 according to some embodiments will now be described with reference to the signaling diagram depicted in FIG. 3. In FIG. 3, the network node 101 is the node responsible for determining the change associated with the current state. The communications link 110 associated with the wireless device 105 is in a current state at the start of the method which is a state in which there is no data transmission on the communications link 110, e.g. state Cell_PCH or URA_PCH for WCDMA. FIG. 3 describes an example of a WCDMA scenario.

In some embodiments, further information than the pure current buffer size associated with data to be transmitted to or received by the wireless device 105, is used in order to determine a transition to another state. The current buffer size may also be an initial buffer size. If it is known that a complete transaction of data for the wireless device 105 is associated with a certain throughput, such further information is used to improve the selection of the transition to the other state. Such further information may be that the transaction of data will lead to a total higher amount of data than the current amount, i.e. the current buffer size, that latency of the data throughput is of high importance, that the transaction is related to a user interactive use case etc.

Depending on the further information associated with the data to be transmitted or received, the network node 101 determines that the communications link 110 between the wireless device 105 and the network node 101 may be transitioned to a particular state. The further information improves the selection of states made by the network node 101 with respect to user latency and user experience, battery drain and system resource consumption.

As mentioned earlier, a problem with the existing technology is that with the current buffer size of the wireless device 105, the network node 101 has no further information relating to the data to be transmitted or received, such as e.g. the use case that has been initiated. The current buffer size shows no correlation to the amount of data that will follow after the current buffer. In the dominant case this current buffer value is small and in most cases this would lead to assign the communications link to the Cell_FACH state and then later make an additional re-assignment to Cell_DCH leading to additional latency. Assigning the communications link to Cell_DCH on every current buffer size leads to unnecessary battery drain and system resource consumption.

The method in FIG. 3 comprises the following steps, which steps may as well be carried out in another suitable order than described below.

### Step 301

This step corresponds to step 201 in FIG. 2. The wireless device 105 detects a data activity which is that it needs to transmit data. The transmittal of data may be to another node in the communications network 100, such as e.g. the network node 101.

### Step 302

This step corresponds to step 202 in FIG. 2. The wireless device 105 obtains information related to the data that it needs to transmit. This data is data other than the current amount of data to be transmitted.

The wireless device 105 including its operating system comprises a multitude of further information to deduce what kind of use case that is causing a current network activity, i.e. causing the need to transmit or receive data. For example, the further information may be the fact that an interaction with a display of the wireless device 105 takes place and that data requests caused at this instant will lead to the transfer of a high amount of data or that such interaction with the display may have the lowest possible latency. In another example, the further information may be regarding the application in the wireless device 105 which causes the data transmission. This application may be activated with the interaction with the display of the wireless device 105. In this case, the decision logic needs information from the operating system of the wireless device 105 about which application that is sending information on the user plane interface and information about which application is in the foreground. The above are only examples of components that may be actively used as information sources in order to decide on the value of an indicator other than a current amount of data associated with the data activity.

This information other than the current amount of data is used to set a value of an indicator for indicating which throughput is needed on the communications link 110.

### Step 303

This step corresponds to step 202 in FIG. 2. In order to get the appropriate value of an indicator, one alternative is to override the value of the indicator that would have been used if the current amount of data were used as a basis for the decision. Another alternative is to change the parameter which is the basis for setting the value of the indicator, i.e. to change the amount of data used as the basis for the decision. Which of these alternatives that are used are dependent on which alternative the network node 101 supports. The wireless device 105 applies the one that the network node 101 supports. It is necessary that the wireless device and the network node 10 have a mutual understanding of which alternative that should be applied. These alternatives will now be described in more detail in steps 304 and 305.

### Step 304

This step corresponds to step 202 in FIG. 2. This step is an alternative to step 305 and describes the override of the value of the indicator. In this step 304, the network node 101 supports override of the indicator. The wireless device 105 determines a value of the indicator. The wireless device 105 bases its decision on information associated with the data activity other than an current amount of data. The further information may indicate that a first throughput or second throughput is needed on the communications link 110. The second throughput is higher than the first throughput.

When the wireless device 105 has determined based on information other than the current amount of data, that a first throughput is needed on the communications link 110, it assigns a first value to the indicator. When the wireless device 105 has determined based on information other than the current amount of data, that a second throughput is needed on the communications link 110, it assigns a second value to the indicator. As mentioned above, the current amount of data in the wireless device transmit buffer is used as basis for setting the value of the indicator in the current technology. However, the embodiments herein use further information other than the current amount as the basis for setting the value of the indicator.

When the wireless device 105 has determined that a first throughput is need on the communications link 101, it assigns a first value to the indicator. This is done regardless of the current amount of data to be transmitted. For example, if the first value of the indicator is zero it may indicate that the first throughput is needed on the communications link 110.

When the wireless device 105 has determined that a second throughput is need on the communications link 101, it assigns a second value to the indicator. This is done regardless of the current amount of data to be transmitted. For example, if the second value of the indicator is one it may indicate that the second throughput is needed on the communications link 110.

Indicator=0->First throughput
Indicator=1->Second throughput

Other values of the indicator instead of zero and 1 as described above are also applicable, such as for example true and false, a flag which is set or not set etc.

Summarized, if the indicator has the first value it indicates the first throughput, and if the indicator has the second value it indicates the second throughput. Thus, the current amount of data may be seen as being disregarded or overridden by using the other information instead. In some embodiments, the indicator may be the TVI. As described above, the TVI is an enumerated information element.

The embodiments herein incorporate other knowledge than the pure buffer size in assigning a value to the indicator. If the wireless device 105 knows by other means that this transaction will lead to a higher amount of data transferred or that latency has priority, that it relates to a user interactive use case, it may indicate this already in the first traffic volume measurement by indicating in the indicator that the buffer size is above the predefined threshold.

### Step 305

This step is an alternative to step 304 and describes the adding an extra amount of data to the current amount of data in order to assign a second value to the indicator which indicates the second throughput. In this step 305, the network node 101 supports the adding of the extra amount of data.

When the wireless device 105 has determined that the second throughput is needed on the communications link 110 based on the information other than the current amount of data to be transmitted, the wireless device 105 calculates a total amount of data to be transmitted by adding an extra amount of data to the current amount of data so that the total amount of data reaches a threshold set by the system. The total amount then implies that the second value may be assigned to the indicator:

Total amount data=current amount of data+extra amount of data

In the current solutions, the value of the indicator is set based on the current amount of data. However, in the embodiment herein, the value of the indicator is set based on the total amount of data instead. By adding the extra amount of data to the current amount of data, the total amount of data will be larger than the current amount. This way, the decision to set the value of the indicator will be based on a “fake” amount of data.

For example, the requirement or threshold to assign the second value to the indicator is that the amount of data is 150 bytes. When the information other than the current amount indicates the second throughput, and if the current amount of data is 80 bytes, the extra amount of data to be added to the current amount will then be 70 bytes.

Total amount of data=80 bytes+70 bytes=150 bytes->assign second value to indicator->second throughput

Thus, the decision to set the second value to the indicator is based on the total amount of data instead of the current amount, which indicates the second throughput.

The indicator may in this case be referred to as an up switch indicator which indicates an amount of data which is larger than the current amount, and is in that sense a false amount. This way, the total amount of data is larger than the current amount, and thus resulting in a second throughput even though the current amount would not indicates such throughput.

When the wireless device 105 has determined that the first value to be assigned to the indicator, the wireless device 105 does not add any extra amount of data. The wireless device 105 uses the current amount in order to assign the first value to the indicator.

### Step 306

This step corresponds to step 203 in FIG. 2. The wireless device 105 transmits the indicator to the network node 101. The indicator in step 306 is part of the information related to the data activity transmitted in step 203 in FIG. 2.

### Step 307

This step corresponds to step 204 in FIG. 2. The network node 101 receives the indicator from the wireless device 105 in step 306 and takes a decision regarding the change associated with the current state based on the indicator. If necessary, the network node 101 may use additional parameters and information in order to determine the change in addition to the indicator from the wireless device 105. Even though the wireless device 105 has determined in steps 304 or 305 that a first or second throughput is needed on the communications link 110, it is the network node 101 which takes the ultimate decision in the embodiments described in FIG. 3.

For example, if the indicator from the wireless device 105 has the first value equals zero, the network node 101 understands that this requires the first throughput on the communications link 110. In order to achieve the first throughput, the state of the communications link 110 must be changed from the current state in which there is no data transmission to the first state, e.g. from Cell_PCH or URA_PCH to Cell_FACH. Similarly, if the indicator from the wireless device 105 has the second value equals one, the network node 101 understands that this requires the second throughput on the communications link 110. In order to achieve the second throughput, the state of the communications link 110 must be changed from the current state in which there is no data transmission to the first state, e.g. from Cell_PCH or URA_PCH to Cell_DCH.

### Step 308

This step corresponds to step 205 in FIG. 2. When the network node 101 has taken a decision regarding the change associated with the current state, it performs the change. The change may be performed by the network node 101 itself, or the network node 101 may transmits instructions to the wireless device 105 indicating the change. The instructions may comprise an indicator having the appropriate value corresponding to the determined different state.

### Step 309

This step corresponds to step 206 in FIG. 2. The wireless device 105 transmits the data according to the change associated with the current state.

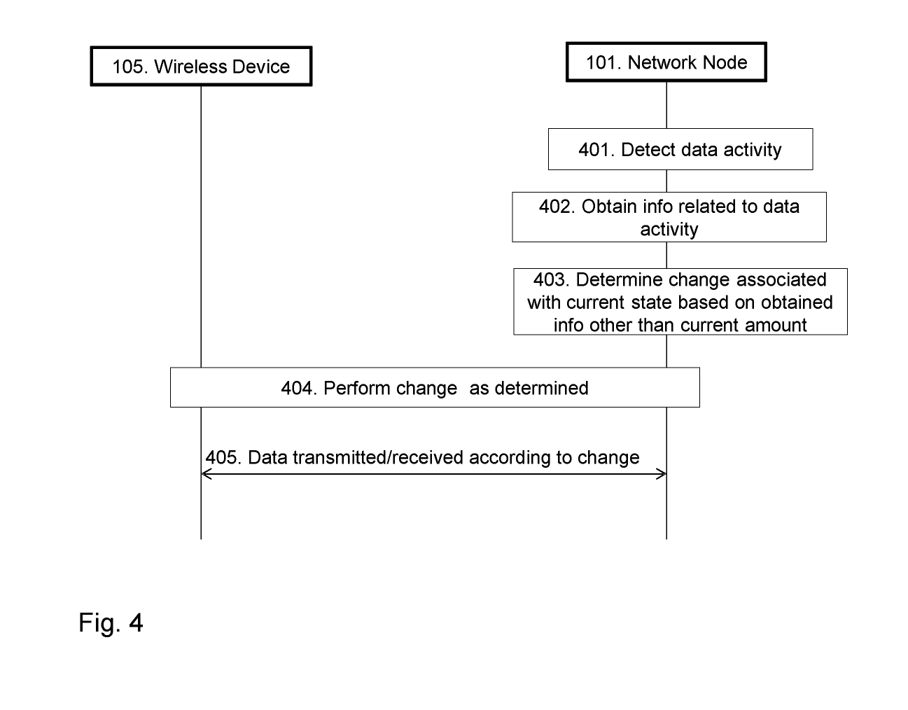

In FIGS. 2 and 3, the change associated with the current state is initiated by the wireless device 105 in the sense that it is the wireless device 105 which detects a data activity. In another embodiment, the change associated with the current state is initiated by the network node 101, i.e. the network node 101 detects the data activity. This embodiment where the network node 101 is the initiator will now be described with reference to the signaling diagram depicted in FIG. 4. In FIG. 4, the network node 101 is the node responsible for determining the change associated with the current state. The communications link 110 associated with the wireless device 105 is in a current state at the start of the method. The method comprises the following steps, which steps may as well be carried out in another suitable order than described below.

### Step 401

The network node 101 detects a data activity. The data activity may be that the network node 101 needs to transmit data. In some embodiments, the need to transmit data is detected by the network node 101 itself, e.g. by periodically checking the amount of data in a buffer. The transmittal of data may be to another node in the communications network 100, such as e.g. the wireless device 105.

### Step 402

The network node 101 obtains information related to the detected data activity.

In some embodiments, this may be pure collection of information related to the data activity and obtained from at least one information data source related to the data activity. In another embodiment, the obtaining of information may also involve deducting which use case is running on the network node 101. The network node 101 may have information about a number of pre agreed use case, and deducts which using case is running based on the pre agreed use cases and the information from its information sources. In a further embodiment, the network node 101 makes a best estimate on use case available. The use cases may be similar to the ones described in step 202 above, and will not be repeated here for the sake of simplicity.

### Step 403

When the network node 101 has obtained the information, it determines a change associated with the current state based on the obtained information.

In WCDMA, the change associated with the current state may be that the network node 101 decides to transmit the data in Cell_FACH or to give low priority to the wireless device 105 in the scheduler. In case of LTE, priority in the scheduler may be lower and DRX settings may be chosen which optimize resources on the expense of latency.

The determined change may also be to change a parameter associated with the current state, which parameter affects the characteristics of the current state.

When network node 101 knows that it needs to transmit data, the network node 101 determines whether there may be a change from the current state to the first state or from the current state to the second state. The network node 101 bases its decision to change state on further information associated with the data activity other than a current amount of data.

In this embodiment where there is a network node 101 initiated transition from the first state, e.g. URA_PCH or Cell_PCH, the network node 101 may base its decision on further information such as knowledge about the particular application causing the data to be transmitted or received, and decide whether there may be a transition immediately to the first state, e.g. Cell_FACH, or to the second state, e.g. Cell_DCH. Knowledge about for example the application may be gathered by Deep Packet Inspection (DPI) to infer information about which application it is, what state it is in and whether the current use case would benefit from an assignment to the first state or the second state, i.e. Cell_FACH or Cell_DCH. Again this knowledge is used to deduce whether the use case will lead to a bigger amount of data being transferred or that latency may have priority.

### Step 404

After the network node 101 has taken its decision, it performs the determined change either by performing the change itself or by transmitting instructions to the wireless device 105 to perform the determined change.

### Step 405

When the change associated with the current state has been performed, the wireless device 105 and the network node 101 communicate according to the performed change.

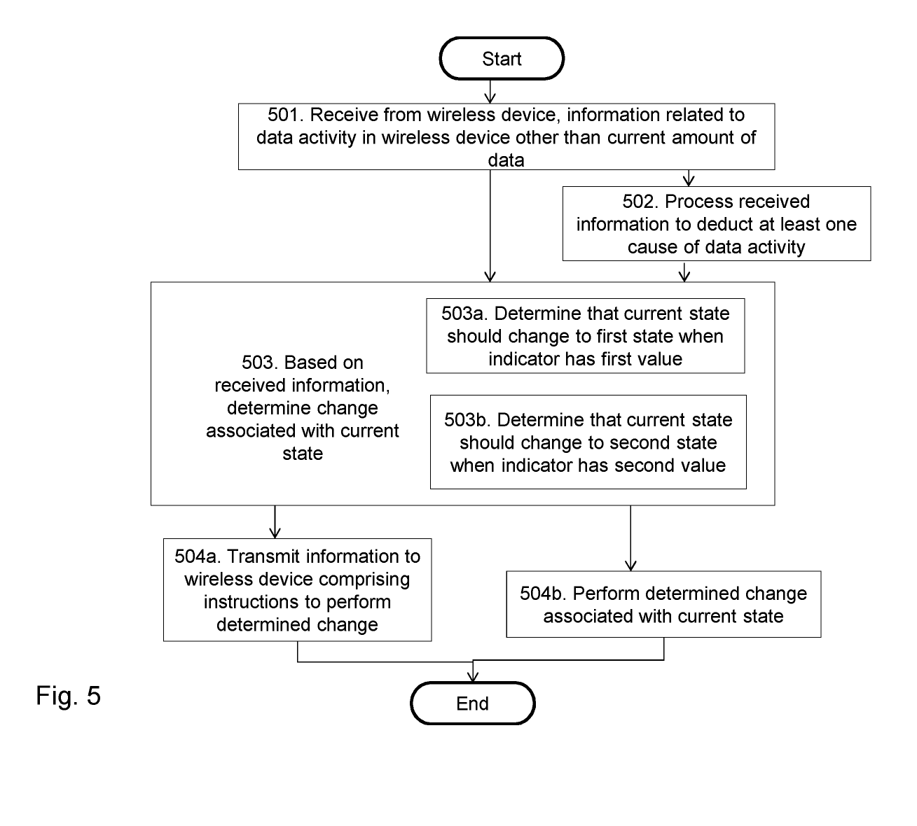

The method described above will now be described seen from the perspective of the network node 101. FIG. 5 is a flowchart describing the present method in the network node 101, for handling states associated with the wireless device 105 in a communications network 100. As mentioned above the network node 101 is connected to the wireless device 105 over a communications link 110. The communications link 110 is in a current state. The current state may be one URA_PCH or Cell_PCH or Cell_FACH, or Cell_DCH when the communications network 100 is a WCDMA network. The current state may be one of idle or DRX in idle mode or awake in connected mode or C-DRX in connected mode when the communications network 100 is a LTE network. The network node 101 may be one of a RNC a base station, a MME or a SGW. The method comprises the following steps to be performed by network node 101, which steps may be performed in any suitable order than described below:

### Step 501

This step corresponds to step 203 in FIG. 2 and step 306 in FIG. 3. The network node 101 receives, from the wireless device 105 information related to a data activity in the wireless device 105. The received information comprises at least information other than a current amount of data associated with the data activity.

The information may be received before start of a data transmission from the wireless device 105 or at start of the data transmission from the wireless device 105 or during the data transmission from the wireless device 105 or at an end of an ongoing data transmission from the wireless device 105.

The received information may be information from at least one information data source in the wireless device 105 and associated with the data activity

In some embodiments, the received information indicates at least one cause of the data activity. The data activity may be caused by at least one of background data from the wireless device 105, and user initiated data from the wireless device 105, and an application in the wireless device 105 requiring prioritized setup of a channel for the application at the network node 101. The background data is non-user initiated and to be executed with a first throughput on the communications link 110.

The received information may further comprise information indicating a time prediction on when a future data transmission is to be expected at the network node 101 after a current data transmission has ended. The time prediction may be for example a time constant in DRX, e.g. a balance between active time and sleep time, an inactivity timer for the duration of a state after the data transmission has ended etc.

In some embodiments, the received information comprises an indicator having a first value or a second value. The value of the indicator indicates a certain throughput needed on the communications link 110. The indicator may be the TVI or it may be an indicator indicating priority of the data activity.

The received information may further comprise information related to the current amount of data associated with the data activity.

The received information may be comprised in a message dedicated to the received information or in a cell update message, or an extension of the cell update message or a measurement report or an extension of the measurement report when the communications network 100 is a WCDMA network. The information is comprised in a message dedicated to the received information or a layer 2 extension when the communications network 100 is a LTE network.

### Step 502

This step corresponds to step 204 in FIG. 2 and step 307 in FIG. 3. In some embodiments, e.g. when information received in step 501 is information from at least one information data source in the wireless device 105 and associated with the data activity, the network node 101 processes the received information to deduct at least one cause of the data activity

This step 502 is not necessarily performed if the received information indicates at least one cause of the data activity. However, if the received information comprises only an estimate of a cause, it may be necessary to perform the processing in order for the network node 101 to establish the “real” cause.

The data activity may be caused by at least one of background data from the wireless device 105, and user initiated data from the wireless device 105, and an application in the wireless device 105 requiring prioritized setup of a channel for the application at the network node 101. The background data is non-user initiated and to be executed with a first throughput on the communications link 110.

### Step 503

This step corresponds to step 204 in FIG. 2 and step 307 in FIG. 3. Based on the received information, the network node 101 determines a change associated with the current state. In some embodiments, the decision is further based on other information obtained by the network node 101 itself. In some embodiments, the decision is further based on the cause of the data activity.

The change associated with the current state may be that the state of the communications link 110 may change from the current state to a different state or that at least one parameter associated with the current state may change. The parameter affects characteristics of the current state. The different state may be one of URA_PCH or Cell_PCH or Cell_FACH or Cell_DCH which the current state is not when the communications network 100 is a WCDMA network. The different state may be one of idle or DRX in idle mode or awake in connected mode or C-DRX in connected mode when the communications network 100 is a LTE network.

### Step 503a

This step corresponds to step 204 in FIG. 2 and step 307 in FIG. 3. This step is a sub step of step 503. In some embodiments, the network node 101 determines that the current state may change to a first state when indicator has the first value. The first state is associated with a first throughput on the communications link 110. The first state may be one of URA_PCH or Cell_PCH or Cell_FACH or Cell_DCH which the current state is not, and when the communications network 100 is a WCDMA network. The first state may be one of idle or DRX in idle mode or awake in connected mode or C-DRX in connected mode which the current state is not and when the communications network 100 is a LTE network. In other words, the current state and the first state are different.

### Step 503b

This step corresponds to step 204 in FIG. 2 and step 307 in FIG. 3. This step is a sub step of step 503. In some embodiments, the network node 101 determines that the current state may change to a second state when the indicator has the second value. The second state is associated with a second throughput on the communications link 110. The second throughput is higher than the first throughput. The second state may be one of URA_PCH or Cell_PCH or Cell_FACH or Cell_DCH which the current state is not, and when the communications network 100 is a WCDMA network. The second state may be one of idle or DRX in idle mode or awake in connected mode or C-DRX in connected mode which the current state is not, and when the communications network 100 is a LTE network. In other words, the current state and the second state are different.

### Step 504a

This step corresponds to step 205 in FIG. 2 and step 308 in FIG. 3. This step is an alternative to step 504b, i.e. a step that is performed instead of step 504b.

In some embodiments, the network node 101 transmits information to the wireless device 105. The information comprises instructions to perform the determined change.

### Step 504b

This step corresponds to step 205 in FIG. 2 and step 308 in FIG. 3. This step is an alternative to step 504a, i.e. a step that is performed instead of step 504a.

In some embodiments, the network node 101 performs the determined change associated with the current state itself.

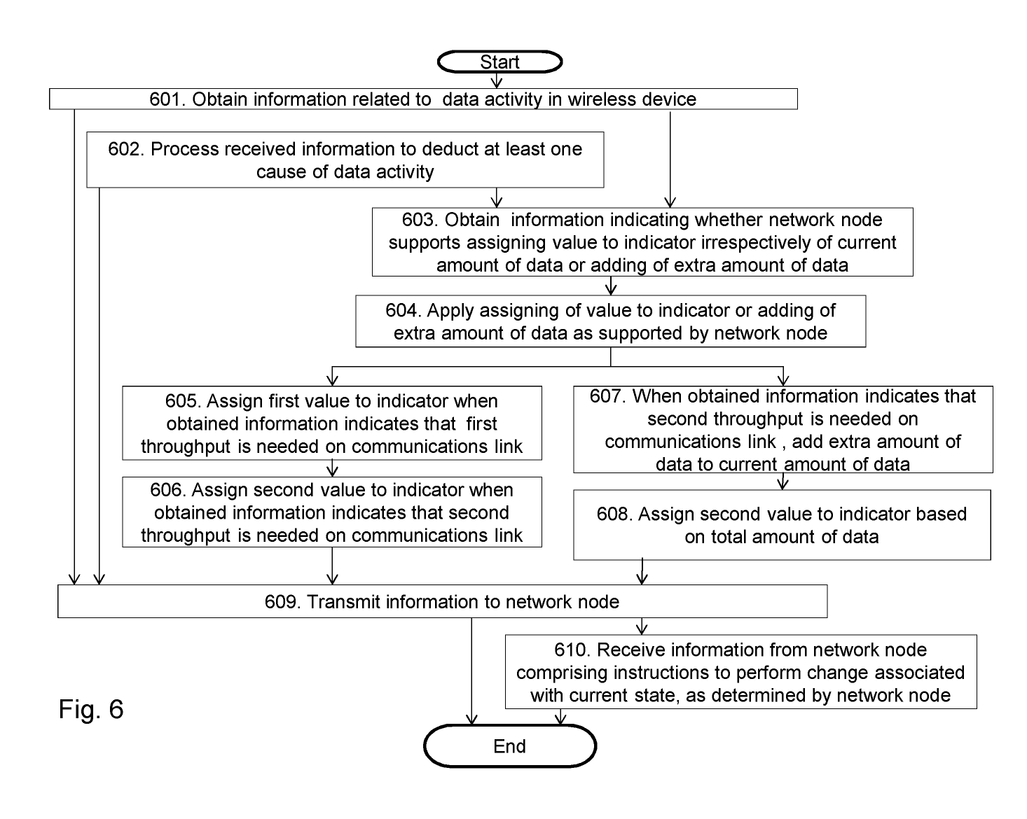

The method described above will now be described seen from the perspective of the wireless device 105. FIG. 6 is a flowchart describing the present method in the wireless device 105 for handling states associated with the wireless device 105 in a communications network 100. The wireless device 105 is connected to the network node 101 over the communications link 110. The network node 101 may be one of a RNC, a base station, a MME or a SGW. The communication link 110 is in a current state. The current state may be one of URA_PCH or Cell_PCH or Cell_FACH or Cell_DCH and when the communications network 100 is a WCDMA network. The current state may be one of idle or DRX in idle mode or awake in connected mode or C-DRX in connected mode, and when the communications network 100 is a LTE network. The method comprises the following steps to be performed by wireless device 105, which steps may be performed in any suitable order than described below:

### Step 601

This step corresponds to step 201 and 202 in FIG. 2 and step 301 and 302 in FIG. 3. The wireless device 105 obtains information related to a data activity in the wireless device 105. The information comprises at least information other than a current amount of data associated with the data activity. In some embodiments, the information is obtained from at least one information source in the wireless device 105 and associated with the data activity. The obtained information may be further related to the current amount of data associated with the data activity.

### Step 602

This step corresponds to step 202 in FIG. 2 and step 302 in FIG. 2. In some embodiments, the wireless device 105 processes the obtained information to deduct at least one cause of the data activity. The data activity may be caused by at least one of background data from the wireless device 105, and user initiated data from the wireless device 105, and an application in the wireless device 105 requiring prioritized setup of a channel for the application at the network node 101. The background data is non-user initiated and to be executed with a first throughput on the communications link 110.

### Step 603

This step corresponds to step 202 in FIG. 2 and step 303 in FIG. 3. In some embodiments, the wireless device 105 obtains information indicating whether the network node 101 supports the assigning the value to the indicator irrespectively of the current amount of data or the adding of the extra amount of data. The indicator may be the TVI.

### Step 604

This step corresponds to step 202 in FIG. 2 and step 303 in FIG. 3. This step is performed if step 603 is performed. In some embodiments, the wireless device 105 applies the assigning of the value to the indicator or the adding of the extra amount of data as supported by the network node 101.

The following steps 605 and 606 are alternatives to steps 607 and 608.

### Step 605

This step corresponds to step 202 in FIG. 2 and step 304 in FIG. 3. In some embodiments, the wireless device 105 assigns a first value to an indicator when the obtained information indicates that a first throughput is needed on the communications link 110.

### Step 606

This step corresponds to step 202 in FIG. 2 and step 304 in FIG. 3. In some embodiments, the wireless device 105 assigns a second value to the indicator when the obtained information indicates that a second throughput is needed on the communications link 110. The second throughput is higher than the first throughput.

### Step 607

This step corresponds to step 202 in FIG. 2 and step 305 in FIG. 3. When the obtained information indicates that a second throughput is needed on the communications link 110, the wireless device 105 adds an extra amount of data to a current amount of data, resulting in a total amount of data which requires the second throughput and which exceeds a threshold. The threshold is determined by the system, i.e. the network node 101.

### Step 608

This step corresponds to step 202 in FIG. 2 and step 305 in FIG. 3. In some embodiments, the network node 101 assigns the second value to the indicator based on the total amount of data from step 605.

### Step 609

This step corresponds to step 203 in FIG. 2 and step 306 in FIG. 3. The wireless device 105 transmits the information to the network node 101.

The information may be transmitted before start of a data transmission from the wireless device 105 or at start of the data transmission from the wireless device 105 or during the data transmission from the wireless device 105 or at an end of an ongoing data transmission from the wireless device 105.

In some embodiments, the information transmitted to the network node 101 indicates the at least one cause of the data activity as obtained in step 602.

The transmitted information may further comprise information indicating a time prediction on when a future data transmission is to be expected at the network node 101 after a current data transmission has ended.

The indicator, e.g. TVI, may be transmitted to the network node 101 together with the obtained information.

The transmitted information may be comprised in a message dedicated to the received information or in a cell update message or an extension of the cell update message or a measurement report or an extension of the measurement report when the communications network 100 is a WCDMA network. The information may be comprised in a message dedicated to the received information or in a layer 2 or layer 3 extension when the communications network 100 is a LTE network.

### Step 610

This step corresponds to step 205 in FIG. 2 and step 308 in FIG. 3. In some embodiments, the wireless device 105 receives information from the network node 101. The information comprises instructions to perform a change associated with the current state, as determined by the network node 101.

The change associated with the current state may be that the state of the communications link 110 may change from the current state to a different state or that at least one parameter associated with the current state may change. The parameter affects characteristics of the current state.

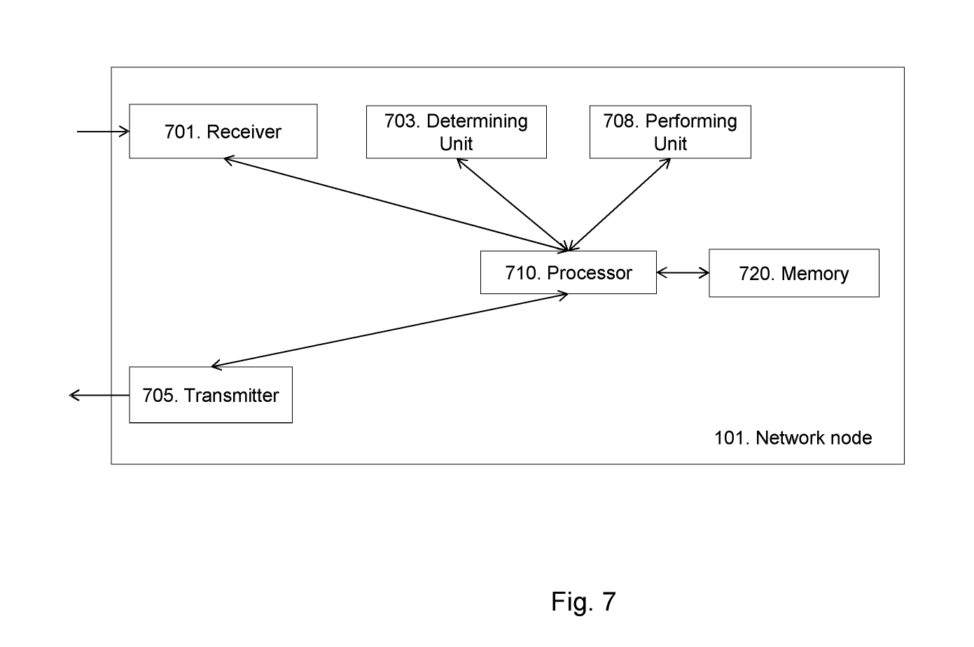

To perform the method steps shown in FIG. 5 for handling states associated with the wireless device 105 in the communications network 100, the network node 101 comprises an arrangement as shown in FIG. 7. The network node 101 is connected to the wireless device 105 over the communications link 110. The communications link 110 is in the current state. The current state may be one of URA_PCH or Cell_PCH or Cell_FACH or Cell_DCH when the communications network 100 is a WCDMA network. The current state may be one of idle or DRX in idle mode or awake in connected mode or C-DRX in connected mode when the communications network 100 is a LTE network. The network node 101 may be one of a RNC, a base station, a MME or a SGW.

The network node 101 comprises a receiver 701 adapted to receive, from the wireless device 105, information related to a data activity in the wireless device 105. The received information comprises at least information other than a current amount of data associated with the data activity. The receiver 701 may be adapted to receive the information before start of a data transmission from the wireless device 105 or at start of the data transmission from the wireless device 105 or during the data transmission from the wireless device 105 or at an end of an ongoing data transmission from the wireless device 105. The received information may be information from at least one information source in the wireless device 105 and associated with the data activity. The received information may indicate at least one cause of the data activity. The data activity may be caused by at least one of background data from the wireless device 105, and user initiated data from the wireless device 105, and an application in the wireless device 105 requiring prioritized setup of a channel for the application at the network node 101. The background data may be non-user initiated and to be executed with a first throughput on the communications link 110. The received information may further comprise information indicating a time prediction on when a future data transmission is to be expected at the network node 101 after a current data transmission has ended. The received information may comprise an indicator having a first value or a second value. The indicator may be the TVI. The received information may further comprise information related to the current amount of data associated with the data activity. The received information may be comprised in a message dedicated to the received information or in a cell update message, or an extension of the cell update message or a measurement report or an extension of the measurement report when the communications network 100 is a WCDMA network. The information is comprised in a message dedicated to the received information or a layer 2 extension when the communications network 100 is a LTE network.

The network node 101 comprises a determining unit 703 adapted to determine, based on the received information, a change associated with the current state. The change associated with the current state may be that the state of the communications link 110 may change from the current state to a different state or that at least one parameter associated with the current state may change. The parameter affects characteristics of the current state. The determining unit 703 may be further adapted to base the decision on other information obtained by the network node 101 itself. The determining unit 703 may be further adapted to determine the change associated with the current state further based on the cause of the data activity. The determining unit 703 may be further adapted to determine that the current state may change to a first state when indicator has the first value. The first state is associated with a first throughput on the communications link 110. The determining unit 703 may be further adapted to determine that the current state may change to a second state when the indicator has the second value. The second state is associated with a second throughput on the communications link 110. The second throughput is higher than the first throughput. The first state and second state is one of URA_PCH or Cell_PCH or Cell_FACH or Cell_DCH which the current state is not when the communications network 100 is a WCDMA network. The first state and the second state is one of idle or DRX in idle mode or awake in connected mode or C-DRX in connected mode which the current state is not, and when the communications network 100 is a LTE network.

In some embodiments, the network node 101 comprises a transmitter 705 adapted to transmit information to the wireless device 105. The information comprises instructions to perform the determined change.

In some embodiments, the network node 101 comprises a performing unit 708 which is adapted to perform the determined change associated with the current state.

In some embodiments, the network node 101 comprises a processor 710 which is adapted to process the received information to deduct at least one cause of the data activity.

The network node 101 may further comprise a memory 720 comprising one or more memory units. The memory 720 is arranged to be used to store data, received data streams, power level measurements, information indicating the data activity other than the current amount of data, the current amount of data, indicators, values, information related to states, changes, instructions, decisions, threshold values, time periods, configurations, schedulings, and applications to perform the methods herein when being executed in the network node 101.

Those skilled in the art will also appreciate that the receiver 701, the determining unit 703, the transmitter 705 and the performing unit 708 described above may refer to a combination of analog and digital circuits, and/or one or more processors configured with software and/or firmware, e.g. stored in a memory, that when executed by the one or more processors such as the processor 710 perform as described above.

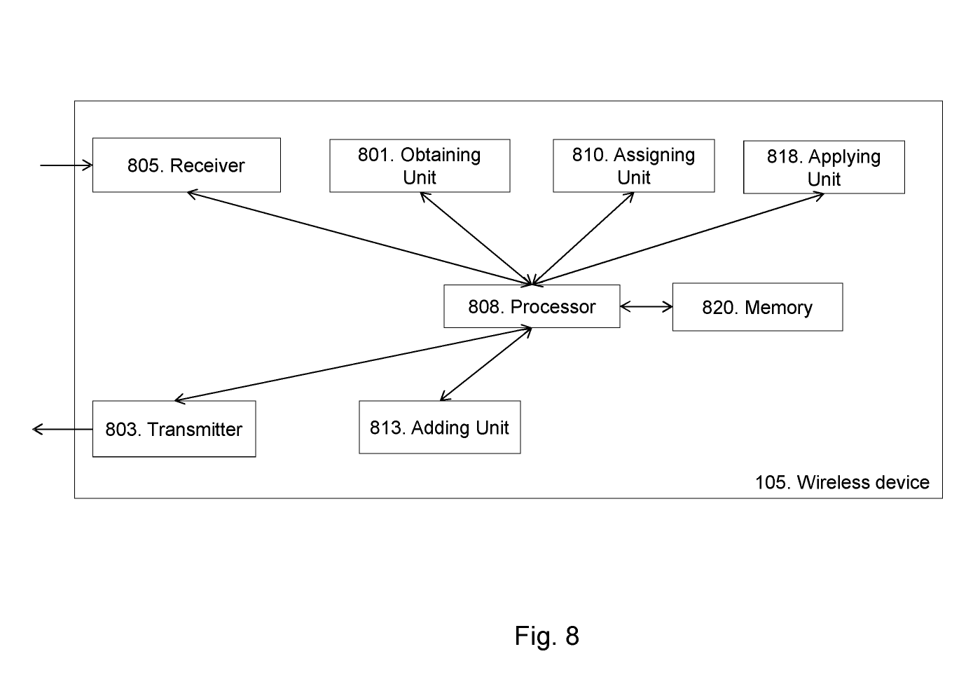

To perform the method steps shown in FIG. 6 for handling states associated with the wireless device 105 in the communications network 100, the wireless device 105 comprises an arrangement as shown in FIG. 8. The wireless device 105 is connected to the network node 101 over the communications link 110. The communications link 110 is in the current state. The current state may be one of URA_PCH or Cell_PCH or Cell_FACH or Cell_DCH when the communications network 100 is a WCDMA network. The current state may be one of idle or DRX in idle mode or awake in connected mode or C-DRX in connected mode when the communications network 100 is a LTE network. The network node 101 is one of a RNC, a base station, a MME or a SGW.

The wireless device 105 comprises an obtaining unit 801 which is adapted to obtain information related to a data activity in the wireless device 105. The information comprises at least information other than a current amount of data associated with the data activity. The information may be obtained from at least one information source in the wireless device 105 and associated with the data activity. The obtaining unit 801 may be adapted to obtain information indicating whether the network node 101 supports the assigning the value to the indicator irrespectively of the current amount of data or the adding of the extra amount of data. The indicator may be the TVI. The obtained information may be further related to the current amount of data associated with the data activity.

The wireless device 105 comprises a transmitter 803 which is adapted to transmit the information to the network node 101. The transmitter 803 may be further adapted to transmit the information before start of a data transmission from the wireless device 105 or at start of the data transmission from the wireless device 105 or during the data transmission from the wireless device 105 or at an end of an ongoing data transmission from the wireless device 105. The information transmitted to the network node 101 may indicate the at least one cause of the data activity. The data activity may be caused by at least one of background data from the wireless device 105, and user initiated data from the wireless device 105, and an application in the wireless device 105 requiring prioritized setup of a channel for the application at the network node 101. The background data is non-user initiated and to be executed with a first throughput on the communications link 110. The transmitted information may further comprise information indicating a time prediction on when a future data transmission is to be expected at the network node 101 after a current data transmission has ended. The indicator may be transmitted to the network node 101 together with the obtained information. The transmitted information may be comprised in a message dedicated to the received information or in a cell update message or an extension of the cell update message or a measurement report or an extension of the measurement report when the communications network 100 is a WCDMA network. The information is comprised in a message dedicated to the received information or in a layer 2 extension when the communications network 100 is a LTE network.

In some embodiments, the wireless device 105 comprises a receiver 805 adapted to receive information from the network node 101. The information comprises instructions to perform a change associated with the current state, as determined by the network node 101. The change associated with the current state may be that the state of the communications link 110 may change from the current state to a different state or that at least one parameter associated with the current state may change. The parameter affects characteristics of the current state.

In some embodiments, the wireless device 105 comprises a processor 808 adapted to process the obtained information to deduct at least one cause of the data activity

In some embodiments, the wireless device 105 comprises an assigning unit 810 adapted to assign a first value to an indicator when the obtained information indicates that a first throughput is needed on the communications link 110. The assigning unit 810 is further adapted to assign a second value to the indicator when the obtained information indicates that a second throughput is needed on the communications link 110. The second throughput is higher than the first throughput. The assigning unit 810 may be adapted to assign a second value to an indicator based on the total amount of data.

The wireless device 105 comprises an adding unit 813 which is adapted to add an extra amount of data to an current amount of data when the obtained information indicates that a second throughput is needed on the communications link 110, resulting in a total amount of data which requires the second throughput and which exceeds a threshold.

The wireless device 105 may comprise an applying unit 818 adapted to apply the assigning of the value to the indicator or the adding of the extra amount of data as supported by the network node 101.

The wireless device 105 may further comprise a memory 820 comprising one or more memory units. The memory 820 is arranged to be used to store data, received data streams, power level measurements, information indicating the data activity other than the current amount of data, the current amount of data, indicators, values, information related to states, changes, instructions, decisions, threshold values, time periods, configurations, schedulings, and applications to perform the methods herein when being executed in the wireless device 105.

Those skilled in the art will also appreciate that the obtaining unit 801, the transmitter 803, the receiver 805, the assigning unit 810, the adding unit 813 and the applying unit 818 described above may refer to a combination of analog and digital circuits, and/or one or more processors configured with software and/or firmware, e.g. stored in a memory, that when executed by the one or more processors such as the processor 808 perform as described above.

The present mechanism for handling states associated with the wireless device 105 in the communications network 100 may be implemented through one or more processors, such as a processor 710 in the arrangement depicted in FIG. 7 and/or the processor 820 in the arrangement depicted in FIG. 8, together with computer program code for performing the functions of the embodiments herein. The processor may be for example a Digital Signal Processor (DSP), Application Specific Integrated Circuit (ASIC) processor, Field-Programmable Gate Array (FPGA) processor or microprocessor. The program code mentioned above may also be provided as a computer program product, for instance in the form of a data carrier carrying computer program code for performing the embodiments herein when being loaded into the network node 101 and/or wireless device 105. One such carrier may be in the form of a CD ROM disc. It is however feasible with other data carriers such as a memory stick. The computer program code may furthermore be provided as pure program code on a server and downloaded to the wireless device 105 and/or network node 101.

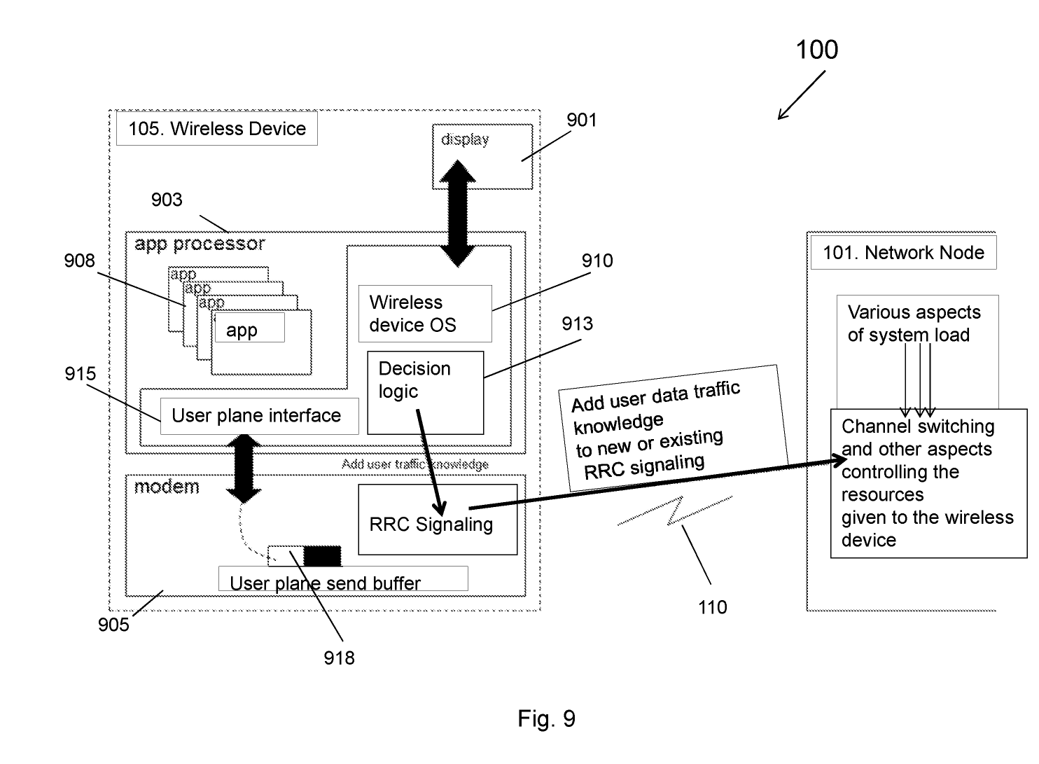

The communications network 100 will now be described with reference to FIG. 9. The wireless device 105 comprises a display 901, an application processor 903 and a modem 905. The application processor 903 comprises a plurality of applications 908 which the user of the wireless device 105 may activate by interacting with the display 901. The applications 908 run on the operating system 910 of the wireless device 105. The operating system 910 has a decision logic 913 which takes decisions. The operating system 910 further comprises a user plane interface 915. The modem 905 comprises a user plane send buffer 918 which has a level of fill according to the current amount of data to be e.g. transmitted or received by the wireless device 105. Based on the level of fill user plane send buffer 918, a traffic volume measurement may be performed. However, based on further information other than the current buffer size, so that the wireless device 105 knows that a certain transaction will lead to a higher amount of data transferred or that latency ha priority, user interactive use case, the decision logic 913 may override the traffic volume value of the indicator so that the correct state is chosen immediately. The indicator is set to the second value since there is high likelihood that a user interactive use case will lead to the transfer of high amount of data and or the fact that a user interactive use case may have the lowest possible latency. The decision logic 913 in the wireless device 105 in this case would only need information about the fact that the user is interacting with the display 901 of the wireless device 105. The dotted line between the user plane send buffer 918 and the user plane interface 915 illustrates the channel between the Application Protocol Interface (API) for the user data down to the modem 905 and the user plane send buffer 918 in order to be able to transmit data on the communications link 110. The decision logic 913 transmits user traffic knowledge down to the RRC signaling unit.

The functionality may be extended with what application 908 is actually causing data transmission if this is also the application 908 that the user is interacting with. In this case the decision logic 913 needs information from the operating system 910 about which application 908 that is sending information on the user plane interface 915 and information on what application 908 is in the foreground. The user traffic knowledge is transmitted to the network node 101 using new or existing RRC signaling.

The embodiment comprising the adding of the extra amount of data to the current amount of data is not shown in FIG. 9. In other words, the case where the decision logic 913 does not override the value of the indicator, but adds data in the user plane interface so that the total amount of data seen by the user plane send buffer 918 is large enough so that the traffic volume measurement itself generates a large enough value of the indicator. This data traffic may be for example an User Datagram Protocol (UDP) packet which does not require any action by the receiver. It may be possible to set a Time To Live (TTL) on that UDP packet to be one, which would means that it will be thrown away in the first router it arrives at and it will never reaches its address.

In the scenario seen in FIG. 9, the overridden indication must be present when the data arrives at the user plane send buffer 918 and the traffic volume measurement is calculated. In the scenario not seen in FIG. 9, an extra amount of data must be transmitted together with the current amount of data so that the user plane send buffer 918 makes a calculation based on the total amount of data, and not each part separately.

When the network node 101 receives the user traffic knowledge it determines a change associated with the current state based on the received information in addition to various aspects related to system load. The change may relate to be channel switching and other aspects controlling the resources given to the wireless device 105.

The embodiments herein bring more knowledge to the state selection and de-selection process and thereby give the possibility to increase user experience and at the same time better utilize the battery and system resources. The embodiments herein bring knowledge available in the wireless device 105 to the system side which is responsible for the control of state switching and the overall resource utilization.

The embodiments herein use explicit information provided by the wireless device 105 to the network node 101. The network node 101 (and possibly in combination with the wireless device 105) uses this information to dynamically optimize channel state switch parameters and/or perform channel state switch.

Summarized, a wireless device according to the current technology transmits information indicating the pure current buffer size to the network node 101 using cell update. The wireless device 105 indicates this with a bit and the network node 101 determines a state change based on this bit. In the embodiments herein, the wireless device 105 transmits information, such as information related to current amount of data, the screen of the wireless device 105, user interaction with the wireless device 105, a type of application running on the wireless device 105, history etc. to the network node 101. Thus, it is possible to include existing information, new information, buffer fill, etc. This information is transmitted to the network node 101 using a redefined cell update, a redefined measuring report, LTE layer 2 extension or a new signaling message. The network node 101 makes a decision to change the current state based on the received information. The embodiments herein enable the possibility to transmit all types of information related to the data activity, in addition to the buffer fill, to the network node 101.

In one embodiment, the wireless device 105 obtains information, such as information related to current amount of data, the screen of the wireless device 105, user interaction with the wireless device 105, a type of application running on the wireless device 105, history etc. Based on this information, the wireless device 105 determines whether first or second throughput is necessary, and signals this to the network node 101. The information is transmitted to the network node 101 using the existing cell update with just one bit to indicate that some type of information related to data activity. The current data amount is not explicitly included in the transmitted information. Instead one bit for priority is included, or a bit for indicating use of first or second throughput.

The embodiments herein are not limited to the above described embodiments. Various alternatives, modifications and equivalents may be used. Therefore, the above embodiments should not be taken as limiting the scope of the embodiments, which is defined by the appending claims.

The term “configured to” used herein may also be referred to as “arranged to” or “adapted to”.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasized that the steps of the methods defined in the appended claims may, without departing from the embodiments herein, be performed in another order than the order in which they appear in the claims.

1-68. (canceled)

69. A network node for handling states associated with a wireless device in a communications network, when the network node is connected to the wireless device over a communications link, the communications link being in a current state, the network node comprising:
a receiver configured to receive, from the wireless device, information related to a data activity in the wireless device, wherein the received information comprises at least information other than a current amount of data associated with the data activity; and
processing circuitry configured to determine, based on the received information, a change associated with the current state.

70. The network node of claim 69, further comprising a transmitter configured to transmit information to the wireless device, the information comprising instructions to perform the determined change, wherein the processing circuitry is further configured to perform the determined change associated with the current state.

71. The network node of claim 69, wherein the change associated with the current state is that the state of the communications link should change from the current state to a different state or that at least one parameter associated with the current state should change, wherein the parameter affects characteristics of the current state.

72. The network node of claim 69, wherein the processing circuitry is further configured to base the decision on other information obtained by the network node itself.

73. The network node of claim 69, wherein the received information is information from at least one information source in the wireless device and associated with the data activity; and wherein the processing circuitry is further configured to:
process the received information to deduct at least one cause of the data activity;
determine the change associated with the current state further based on the cause of the data activity.

74. The network node of claim 73, wherein the data activity is caused by at least one of background data from the wireless device, and user initiated data from the wireless device, and an application in the wireless device requiring prioritized setup of a channel for the application at the network node, and wherein the background data is non-user initiated and to be executed with a first throughput on the communications link.

75. The network node of claim 69, wherein the received information indicates at least one cause of the data activity, and wherein the processing circuitry is further configured to determine the change associated with the current state further based on the cause of the data activity.

76. The network node of claim 69, wherein the received information further comprises information indicating a time prediction on when a future data transmission is to be expected at the network node after a current data transmission has ended.

77. The network node of claim 69, wherein the received information comprises an indicator having a first value or a second value, and wherein the processing circuitry is further configured to:
determine that the current state should change to a first state when indicator has the first value, wherein the first state is associated with a first throughput on the communications link; and
determine that the current state should change to a second state when the indicator has the second value, wherein the second state is associated with a second throughput on the communications link, and wherein the second throughput is higher than the first throughput.

78. The network node of claim 69, wherein the communications network is a Long Term Evolution (LTE) network and the received information is comprised in a message dedicated to the received information or a layer 2 extension.

79. A wireless device for handling states associated with the wireless device in a communications network when the wireless device is connected to a network node over a communications link, the communication link being in a current state, the wireless device comprising:
processing circuitry configured to obtain information related to a data activity in the wireless device, wherein the information comprises at least information other than an current amount of data associated with the data activity; and
a transmitter configured to transmit the information to the network node.

80. The wireless device of claim 79, further comprising a receiver configured to receive information from the network node, which information comprises instructions to perform a change associated with the current state, as determined by the network node.

81. The wireless device of claim 80, wherein the change associated with the current state is that the state of the communications link should change from the current state to a different state or that at least one parameter associated with the current state should change, wherein the parameter affects characteristics of the current state.

82. The wireless device of claim 79, wherein the processing circuitry is further configured to process the obtained information to deduct at least one cause of the data activity, and wherein the information transmitted to the network node indicates the at least one cause of the data activity.

83. The wireless device of claim 79, wherein the data activity is caused by at least one of background data from the wireless device, and user initiated data from the wireless device, and an application in the wireless device requiring prioritized setup of a channel for the application at the network node, and wherein the background data is non-user initiated and to be executed with a first throughput on the communications link.

84. The wireless device of claim 79, wherein the transmitted information further comprises information indicating a time prediction on when a future data transmission is to be expected at the network node after a current data transmission has ended.

85. The wireless device of claim 79, wherein the processing circuitry is further configured to:
assign a first value to an indicator when the obtained information indicates that a first throughput is needed on the communications link; and to
assign a second value to the indicator when the obtained information indicates that a second throughput is needed on the communications link, wherein the second throughput is higher than the first throughput.

86. The wireless device of claim 85, wherein the indicator is transmitted to the network node together with the obtained information.

87. The wireless device of claim 79, wherein the communications network is a Long Term Evolution (LTE) network and the transmitted information is comprised in a message dedicated to the received information or in a layer 2 extension.
